(19) United States
(12) Patent Application Publication
(10) Pub. No.: US 2009/0054564 A1
(43) Pub. Date: Feb. 26, 2009

(54) Piperazine polyphosphate, methods for its preparation and its use

(75) Inventors: Frank Eisentraeger, St Pere de Ribes (ES); Sebastian Hoerold, Diedorf (DE); Wolfgang Wanzke, Augsburg (DE); Michael Hill, Koeln (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/229,434

(22) Filed: Aug. 22, 2008

(30) Foreign Application Priority Data
Aug. 22, 2007 (DE) 10 2007 039 559.2

(51) Int. Cl. C08K 5/3462; C09K 21/10; C09K 21/12

(52) U.S. Cl. 524/100; 252/609

(57) ABSTRACT

The invention relates to a piperazine polyphosphate which has an average chain length of from 2.2 to 10 phosphate units, to a method for its preparation and to its use.

The invention relates to piperazine polyphosphate, to methods for its preparation and to its use.

WO-2005/037 806 describes a piperazine pyrophosphate which is obtained through condensation of two piperazine phosphate units. It also describes that impurities (with piperazine phosphate) lead to a lowering of the decomposition temperature of this product. The purest piperazine pyrophosphates have a decomposition temperature of 324° C. (5% weight loss, WL).

DE-A-101 45 093 describes that a piperazine polyphosphate can be prepared from phosphorus pentoxide and piperazine (in the molar ratio 1:2) and a water donor.

WO-2006/027 340 describes that in the case of polyphosphate salts with amine bases, a low solubility in water and a low conductivity are of importance for the application as flame retardants.

EP-A-1 277 794 describes the flame-retardancy of a melamine pyrophosphate with a reaction product of a mixture of phosphoric acid (50%), pyrophosphoric acid (30%), triphosphoric acid (15%) and other polyphosphoric acids (5%) with piperazine in the molar ratio 1:1.

For medical applications, e.g. as deworming agents, the solubility in water is directly related to the availability within the body. With a low solubility in water, long-lasting effects can be achieved.

In the application of piperazine polyphosphate as flame retardant, the decomposition temperature limits the processing window for incorporation into the polymer composition. A high decomposition temperature, on the other hand, permits the use in a broad spectrum of polymers under highly diverse conditions.

The piperazine phosphate compounds and piperazine polyphosphates described hitherto, however, have disadvantages with regard to (generally too high) solubility in water, acid number, conductivity and (generally too low) decomposition temperature which prevent broader use.

It was thus the object to synthesize a piperazine polyphosphate with low solubility in water, low conductivity, low acid number and high decomposition temperature.

As regards the method, the object was to carry this out on the basis of favorable raw materials and in a single reaction step without diverse secondary products being formed.

Surprisingly, it has now been found that piperazine polyphosphates with a chain length of from 2.2 to 10 at a molar piperazine to phosphorus pentoxide ratio of from 0.9 to 1.5:1 have a particularly low solubility in water, acid number and conductivity, favorable color numbers, low residual moistures and a high decomposition temperature.

The invention therefore relates to a piperazine polyphosphate which has an average chain length of from 2.2 to 10 phosphate units, a chain length distribution where:

| | |
|---|---|
| chain length 1 | 0.5 to 10% |
| chain length 2 | 2 to 30% |
| chain length 3 | 4 to 30% |
| chain length 4 | 0 to 90% |
| chain length 5 | 1 to 25% |
| chain length 6 | 1 to 25% |
| chain length 7 | 1 to 40% |
| chain length 8 and above | 0.5 to 40%, |

the acid number of the filtrate of a 10% strength suspension thereof is between 200 and 400 mg KOH/g and which has a solubility in water of at most 7%.

Particularly preferably, the piperazine polyphosphate has the following chain length distribution:

| | |
|---|---|
| chain length 1 | 0.5 to 5% |
| chain length 2 | 2 to 20% |
| chain length 3 | 4 to 20% |
| chain length 4 | 30 to 90% |
| chain length 5 | 1 to 15% |
| chain length 6 | 1 to 15% |
| chain length 7 | 1 to 30% |
| chain length 8 and above | 0.5 to 30%. |

The sum of the chain length distributions are therefore always 100%.

Preferably, a 10% strength suspension of the piperazine polyphosphate in water has a pH between 2.0 and 5.5.

The acid number of the filtrate of a 10% strength suspension of the piperazine polyphosphate is preferably between 200 and 400 mg KOH/g.

The invention also relates to a method for the preparation of piperazine polyphosphate, which comprises reacting liquid and/or gaseous piperazine and polyphosphoric acid with one another.

In a preferred embodiment, the method for the preparation of piperazine polyphosphate comprises reacting polyphosphoric acid and piperazine in a solvent with one another.

In another embodiment, the method for the preparation of piperazine polyphosphate comprises reacting a salt of an amine base of the polyphosphoric acid in aqueous solution with piperazine.

The invention also relates to the use of piperazine polyphosphate as claimed in at least one or more of claims 1 to 4 as flame retardant, in particular for clearcoats and intumescent coatings, flame retardants for wood and other cellulosic products, for or in plastics, wood, paper and textile, and also in coatings for steel and wood fire protection; as reactive and/or nonreactive flame retardant for polymers, for the production of flame-retardant polymer molding compositions, for the production of flame-retardant polymer moldings, films, threads and fibers and/or for the flame-retardant finishing of polyesters and cellulose single and blended fabrics by impregnation.

Finally, the invention also relates to the use of piperazine polyphosphate as claimed in at least one or more of claims 1 to 4
as intermediate for further syntheses,
as binder,
as crosslinker and/or accelerator during the curing of epoxy resins, polyurethanes, unsaturated polyester resins,
as polymer stabilizers,
as crop protection agent,
as therapeutic or additive in therapeutics for humans and animals,
as sequestrant,
as mineral oil additive,
as corrosion protectant,
in detergent and cleaner applications,
in electronics applications.

The invention also relates to a flame-retardant thermoplastic and/or thermosetting polymer molding composition comprising 0.5 to 45% by weight of piperazine polyphosphate as claimed in at least one or more of claims 1 to 4, 0.5 to 95% by weight of thermoplastic polymer or mixtures thereof, 0 to 55% by weight of additives and 0 to 55% by weight of filler and/or strengthening materials, where the sum of the components is 100% by weight.

Finally, the invention also relates to flame-retardant thermoplastic and/or thermosetting polymer moldings, films, threads and fibers, comprising 0.5 to 45% by weight of piperazine polyphosphate as claimed in at least one or more of claims 1 to 4, 0.5 to 95% by weight of thermoplastic polymer or mixtures thereof, 0 to 55% by weight of additives and 0 to 55% by weight of filler and/or strengthening materials, where the sum of the components is 100% by weight.

In the case of the piperazine polyphosphate according to the invention, the pH of a 10% strength suspension thereof in water can also be between 3 and 6.

In the case of the piperazine polyphosphate according to the invention, the acid number of the filtrate of a 10% strength suspension thereof can also be between 100 mg KOH/g and 500 mg KOH/g.

The piperazine polyphosphate according to the invention exhibits a solubility in water of less than 5% and particularly preferably less than 4%.

The piperazine polyphosphate according to the invention has a conductivity of from 1000 to 12 000 μS/cm in a 10% strength suspension.

In the case of the piperazine polyphosphate according to the invention, the temperature at 5% weight loss—a measure of the thermostability—is between 290° C. and 400° C., preferably between 300° C. and 380° C. and particularly preferably between 320° C. and 370° C.

Preferably, the piperazine polyphosphate according to the invention has an average particle diameter (d50) of less than 100 μm, preferably less than 50 μm and particularly preferably <30 μm.

Preferably, in the case of the piperazine polyphosphate according to the invention, the residual moisture is less than 1%, preferably less than 0.5% and particularly preferably less than 0.1%.

Furthermore, the invention also relates to a piperazine polyphosphate, wherein a piperazine-phosphorus pentoxide ratio (equivalent to the N:P ratio) of 0.9-1.5:1 is present. Preference is given to a piperazine polyphosphate with an N:P ratio of 0.9-1.2:1, particular preference is given to an N:P ratio of 0.9-1.0:1.

Furthermore, the invention relates to a piperazine polyphosphate, wherein the color numbers of the product vary within the following limits: the color number L is between 70 and 100, particularly preferably between 80 and 100.

The color number a is between 0 and 3.0, particularly preferably between 0 and 1.5. The color number b is between 0 and 8, preferably between 0 and 6 and particularly preferably between 0 and 5.The present invention further provides a method for the preparation of piperazine polyphosphate. The method according to the invention is preferably carried out in a spray tower in which liquid and/or gaseous piperazine and polyphosphoric acid are reacted with one another. The temperature of the polyphosphoric acid here is 50 to 250° C., particularly preferably 100° C. to 200° C., the temperature of the piperazine is 110° C. to 150° C.

In addition, methods according to the invention can be carried out such that polyphosphoric acid in a suitable aggregate is reacted with gaseous piperazine.

Furthermore, methods according to the invention can be carried out such that polyphosphoric acid and piperazine in a solvent are reacted. Here, preference is given to using solvents which dissolve piperazine. An inert solvent at temperatures close to or above the melting point of piperazine can likewise be used. The product is then separated off from the solvent by filtration or distillation.

Furthermore, the method according to the invention can be carried out such that polyphosphoric acid and piperazine are added simultaneously in liquid and/or gaseous form to a reactor with mixing and grinding elements. In this method, the reactor may be empty or already contain a finished-product bed of piperazine polyphosphate.

The method according to the invention can either be carried out continuously or discontinuously.

Furthermore, the method according to the invention can be carried out such that a salt of an amine base of the polyphosphoric acid (ammonium salts of polyphosphoric acid, e.g. ammonium polyphosphate) in aqueous solution is reacted with piperazine. The product is filtered off and dried.

Preferably, the reaction of piperazine and polyphosphoric acid is carried out under the autogenous vapor pressure of the piperazine and/or the solvent.

In particular, the reaction takes place in an atmosphere which comprises further gaseous constituents, such as, for example, nitrogen, oxygen, argon etc.

Preferably, the reaction takes place at a partial pressure of the piperazine of from 0.01 to 100 bar.

Particularly preferably, the reaction takes place at a partial pressure of the piperazine of from 0.1 to 10 bar.

Preferably, the reaction is carried out at a temperature of from −20 to 340° C.

Particularly preferably, the reaction takes place at a temperature of from 20 to 270° C.

Preferably, the reaction takes place at a total pressure of from 1 to 100 bar.

Preferably, the reaction takes place in a piperazine-polyphosphoric acid ratio, characterized by a piperazine-phosphorus pentoxide ratio (equivalent to the N:P ratio) of 0.9-1.5:1. Particular preference is given to an N:P ratio of 0.9-1.2:1. Very particular preference is given to an N:P ratio of 0.9-1.0:1.

Suitable solvents are water, alcohols, such as, for example, methanol, ethanol, isopropanol, n-propanol, n-butanol, isobutanol, t-butanol, n-amyl alcohol, isoamyl alcohol, t-amyl alcohol, n-hexanol, n-octanol, isooctanol, n-tridecanol, benzyl alcohol etc.

Preference is furthermore given to glycols, such as, for example, ethylene glycol, 1,2-propanediol, 1,3-propanediol, 1,3-butanediol, 1,4-butanediol, diethylene glycol etc.; aliphatic hydrocarbons, such as pentane, hexane, heptane, octane, and petroleum ether, petroleum benzine, kerosene, petroleum, paraffin oil etc.; aromatic hydrocarbons, such as benzene, toluene, xylene, mesitylene, ethylbenzene, diethylbenzene etc.; halogenated hydrocarbons, such as methylene chloride, chloroform, 1,2-dichloroethane, chlorobenzene, carbon tetrachloride, tetrabromoethylene etc.; alicyclic hydrocarbons, such as cyclopentane, cyclohexane, and methylcyclohexane etc.; ethers, such as anisole (methyl phenyl ether), t-butyl methyl ether, dibenzyl ether, diethyl ether, dioxane, diphenyl ether, methyl vinyl ether, tetrahydrofuran, triisopropyl ether etc.; glycol ethers, such as diethylene glycol diethyl ether, diethylene glycol dimethyl ether (diglyme), diethylene glycol monobutyl ether, diethylene glycol monomethyl ether, 1,2-dimethoxyethane (DME monoglyme), ethylene glycol monobutyl ether, triethylene glycol dimethyl ether (triglyme), triethylene glycol monomethyl ether etc.; ketones, such as acetone, diisobutyl ketone, methyl n-propyl ketone; methyl ethyl ketone, methyl isobutyl ketone etc.; esters, such as methyl formate, methyl acetate, ethyl acetate, n-propyl acetate and n-butyl acetate etc.; carboxylic acids, such as formic acid, acetic acid, propionic acid, butyric acid etc. One or more of these compounds can be used alone or in combination.

Furthermore, suitable solvents include piperazine and polyphosphoric acid. These offer advantages in the form of a higher space-time yield.

For all of the described methods, it is favorable to temper the resulting product. This is preferably carried out at temperatures between 150° C. and 290° C., particularly preferably at temperatures between 170° C. and 250° C.

Appropriate choice of the polyphosphoric acid used (degree of concentration) and the reaction temperature results in specific chain length distributions.

Here, the proportion of longer-chain product increases with increasing concentration of the polyphosphoric acid. The temperature likewise influences the chain length distribution.

With 76% strength polyphosphoric acid, the main component of the piperazine polyphosphate has a chain length of 1, with 81% strength polyphosphoric acid, of 2 and above 84% strength polyphosphoric acid, of 4, where with 85 and 86% strength polyphosphoric acid, the proportion of components with chain lengths greater than 4 increases. This can be seen as follows:

Preferably, the piperazine polyphosphate prepared from 76% strength polyphosphoric acid and piperazine has the following chain length distribution:

| | |
|---|---|
| chain length 1 | 55 to 85% |
| chain length 2 | 15 to 45% |
| chain length 3 | 0 to 5% |
| chain length 4 | 0 to 5% |
| chain length 5 | 0 to 2% |
| chain length 6 | 0 to 2% |
| chain length 7 | 0 to 1% |
| chain length 8 and above | 0 to 1%. |

Preferably, the piperazine polyphosphate prepared from 81% strength polyphosphoric acid and piperazine has the following chain length distribution:

| | |
|---|---|
| chain length 1 | 0 to 10% |
| chain length 2 | 70 to 100% |
| chain length 3 | 0 to 10% |
| chain length 4 | 0 to 20% |
| chain length 5 | 0 to 5% |
| chain length 6 | 0 to 5% |
| chain length 7 | 0 to 2% |
| chain length 8 and above | 0 to 2%. |

Preferably, the piperazine polyphosphate prepared from 84% strength polyphosphoric acid and piperazine has the following chain length distribution:

| | |
|---|---|
| chain length 1 | 0 to 10% |
| chain length 2 | 20 to 60% |
| chain length 3 | 0 to 15% |
| chain length 4 | 20 to 60% |
| chain length 5 | 0 to 10% |
| chain length 6 | 0 to 10% |
| chain length 7 | 0 to 10% |
| chain length 8 and above | 0 to 5%. |

Preferably, the piperazine polyphosphate prepared from 85% strength polyphosphoric acid and piperazine has the following chain length distribution:

| | |
|---|---|
| chain length 1 | 0 to 10% |
| chain length 2 | 0 to 25% |
| chain length 3 | 0 to 20% |
| chain length 4 | 50 to 90% |
| chain length 5 | 0 to 10% |
| chain length 6 | 0 to 10% |
| chain length 7 | 0 to 10% |
| chain length 8 and above | 0 to 5%. |

Preferably, the piperazine polyphosphate prepared from 86% strength polyphosphoric acid and piperazine has the following chain length distribution:

| | |
|---|---|
| chain length 1 | 0 to 5% |
| chain length 2 | 0 to 15% |
| chain length 3 | 0 to 20% |
| chain length 4 | 55 to 75% |
| chain length 5 | 0 to 15% |
| chain length 6 | 0 to 15% |
| chain length 7 | 0 to 30% |
| chain length 8 and above | 0 to 30%. |

The sum of the chain length distribution is 100% in each case.

The invention likewise provides the use of the described piperazine polyphosphates as flame retardants, the use of these flame retardants in plastics, wood and paper, and also the use in coatings for steel and wood fire protection.

Furthermore, the invention provides the use of the described piperazine polyphosphates
as binders e.g. for foundry compositions and molding sands,
as crosslinkers and/or accelerators during the curing of epoxy resins, polyurethanes, unsaturated polyester resins,
as polymer stabilizers, e.g. as photoprotective stabilizer and/or thermostabilizers for cotton fabric, polymer fibers, plastics etc.,
as crop protection agents, e.g. as plant growth regulator, as herbicide, pesticide, fungicide, etc.,
as therapeutic or additive in therapeutics for humans and animals, e.g. as enzyme modulator, for stimulating tissue growth,
as sequestrants e.g. for controlling deposits in industrial water pipe systems, in the recovery of mineral oil and in metal treatment compositions,
as mineral oil additive, e.g. as antioxidant and for increasing the octane number,
as corrosion protectant,
in detergent and cleaner applications, e.g. as decolorizing agents,
in electronics applications, e.g. in polyelectrolytes for capacitors, batteries and accumulators, and also as free-radical scavengers in photosensitive layers.

The invention further provides the use of the claimed piperazine polyphosphates for pharmaceutical purposes.

The examples below serve to illustrate the present invention without limiting the subject matter of the invention.

### EXAMPLES

### Example 1

650 g of polyphosphoric acid with a P₂O₅ content of 81% are initially introduced into a kneader and, at a temperature of 115° C., 383 g of piperazine are added in portions (ratio of piperazine:phosphorus pentoxide 1.2:1). When the addition is complete, a fine powder is formed.

### Example 2

175 g of polyphosphoric acid (81%) are admixed with 86 g of piperazine in toluene under reflux (110° C.). (Ratio of piperazine:phosphorus pentoxide 1:1). A precipitate is immediately formed, which is filtered off and freed from solvent residues in vacuo. Yield: 98.4%

### Example 3

668 g of polyphosphoric acid with a P₂O₅ content of 85% are introduced into a kneader at 200° C. over one hour at the same time as 344.4 g of piperazine (ratio of piperazine:phosphorus pentoxide 1:1). After a postreaction time of 10 minutes, the piperazine polyphosphate is removed.

### Example 4

86 g of piperazine are mixed with 194 g of ammonium polyphosphate (Exolit® AP 412, Clariant Produkte (Deutschland) GmbH) and suspended in water. During this operation, ammonia is liberated and the water heats up. After 2 h, 100 ml of methanol are added and filtered off from the insoluble precipitate. The solid is dried.

### Example 5

668 g of polyphosphoric acid with a P₂O₅ content of 86% are reacted in a kneader with 348.5 g of piperazine (ratio of piperazine:phosphorus pentoxide 1:1) at 230° C. over one hour. After a tempering time of 60 minutes, the product is removed. Using ion chromatography, chain length 4 is identified as the main product.

### Example 6 (Comparison)

As described in DE-A-101 45 093, 861 g (10 mol) of piperazine are mixed with 710 g (5 mol) of phosphorus pentoxide in a kneader and heated to 100° C. (Molar ratio of piperazine: phosphorus pentoxide 2:1).

Then, over the course of 15 minutes, 210 g (1.7 mol) of oxalic acid dihydrate are added. The postreaction time is one hour before the resulting piperazine polyphosphate is removed.

TABLE 1
Analysis values for examples 1 to 6

| | Temperature | | | | Solubility in | |
|---|---|---|---|---|---|---|
| | of 5% WL | Chain length | Conductivity | Acid number | water | Residual |
| | [° C.] | (NMR) | [μS/cm] | [mg KOH/g] | [%] | moisture |
| Ex. 1 | 328 | 2.6 | 10240 | 328 | 2.1 | 0.16 |
| Ex. 2 | 331 | 2.4 | 11347 | 347 | 2.4 | 0.05 |
| Ex. 3 | 364 | 4.3 | 9100 | 265 | 4.3 | 0.09 |
| Ex. 4 | 369 | 73 | 1853 | 3.0 | 0.3 | 0.72 |
| Ex. 5 | 340 | 5.3 | 8800 | 251 | 3.7 | 0.08 |
| Ex. 6 | 151 | 1.5 | 51000 | n.d. | 10 | 0.17 |
| (comparison) | | | | | | |

Compared with the piperazine polyphosphate according to the prior art (example 6), the piperazine polyphosphates of examples 1 to 5 according to the invention advantageously have higher decomposition temperatures, lower conductivities and lower solubilities in water.

1. A piperazine polyphosphate, wherein the piperazine polyphosphate has an average chain length of from 2.2 to 10 phosphate units, and a chain length distribution where:

| | |
|---|---|
| chain length 1 | 0.5 to 10% |
| chain length 2 | 2 to 30% |
| chain length 3 | 4 to 30% |
| chain length 4 | 0 to 90% |
| chain length 5 | 1 to 25% |
| chain length 6 | 1 to 25% |
| chain length 7 | 1 to 40% |
| chain length 8 and above | 0.5 to 40%, |

a 10% strength suspension thereof in water has a pH between 1.5 and 7, the acid number of the filtrate of a 10% strength suspension thereof is between 200 and 400 mg KOH/g and wherein it has a solubility in water of at most 7%.

2. The piperazine polyphosphate as claimed in claim 1, wherein the piperazine polyphosphate has the following chain length distribution:

| | |
|---|---|
| chain length 1 | 0.5 to 5% |
| chain length 2 | 2 to 20% |
| chain length 3 | 4 to 20% |
| chain length 4 | 30 to 90% |
| chain length 5 | 1 to 15% |
| chain length 6 | 1 to 15% |
| chain length 7 | 1 to 30% |
| chain length 8 and above | 0.5 to 30%. |

3. The piperazine polyphosphate as claimed in claim 1, wherein a 10% strength suspension thereof in water has a pH between 2 and 5.5.

4. The piperazine polyphosphate as claimed in claim 1, wherein the acid number of the filtrate of a 10% strength suspension thereof is between 200 and 400 mg KOH/g.

5. A method for the preparation of piperazine polyphosphate, comprising the step of reacting liquid piperazine, gaseous piperazine or both with polyphosphoric acid.

6. A method for the preparation of piperazine polyphosphate, comprising the step of reacting polyphosphoric acid with piperazine in the presence of a solvent.

7. A method for the preparation of piperazine polyphosphate, comprising the step of reacting a salt of an amine base of the polyphosphoric acid in aqueous solution with piperazine.

8. A flame retardant comprising a piperazine polyphosphate as claimed in claim 1.

9. A composition comprising a piperazine polyphosphate as claimed in claim 1, wherein the composition is in the form of
an intermediate for further syntheses,
a binder,
a crosslinker, and/or accelerator or both during the curing of epoxy resins, polyurethanes or unsaturated polyester resins,
a polymer stabilizers,
a crop protection agent,
a therapeutic or additive in therapeutics for humans and animals,
a sequestrant,
a mineral oil additive,
a corrosion protectant,
a detergent or cleaner application, or
an electronic article.

10. A flame-retardant thermoplastic or thermosetting polymer molding composition comprising 0.5 to 45% by weight of a piperazine polyphosphate as claimed in claim 1, 0.5 to 95% by weight of a thermoplastic polymer or a mixture thereof, 0 to 55% by weight of additives and 0 to 55% by weight of filler, strengthening materials, or both, where the sum of the components is 100% by weight.

11. A flame-retardant thermoplastic or thermosetting polymer molding, film, thread or fiber, comprising 0.5 to 45% by weight of a piperazine polyphosphate as claimed in claim 1, 0.5 to 95% by weight of a thermoplastic polymer or mixture thereof, 0 to 55% by weight of additives and 0 to 55% by weight of filler, strengthening materials, or both, where the sum of the components is 100% by weight.

12. A clearcoat or intumescent coating flame retardant comprising a piperazine polyphosphate as claimed in claim 1.

13. A flame retardant for wood, cellulosics, plastic, paper or textiles comprising a piperazine polyphosphate as claimed in claim 1.

14. A flame retardant for steel coating or wood fire protection comprising a piperazine polyphosphate as claimed in claim 1.

15. A flame retardant for polymers, for the production of flame-retardant polymer molding compositions, for the production of flame-retardant polymer moldings, films, threads or fibers comprising a piperazine polyphosphate as claimed in claim 1.

16. A flame retardant for the finishing of polyesters or cellulose single and blended fabrics by impregnation comprising a piperazine polyphosphate as claimed in claim 1.
